(19) United States
(12) Patent Application Publication
(10) Pub. No.: US 2019/0070058 A1
(43) Pub. Date: Mar. 7, 2019

(54) ORTHOPEDIC DEVICE

(71) Applicant: OTTOBOCK SE & CO. KGAA, Duderstadt (DE)

(72) Inventors: Annedore KURZWEG, Gottingen (DE); Olaf KROLL-ORYWAHL, Northeim (DE); Jonas BORNMANN, Duderstadt (DE)

(73) Assignee: OTTOBOCK SE & CO. KGAA, Duderstadt (DE)

(21) Appl. No.: 16/085,425

(22) PCT Filed: Mar. 14, 2017
(86) PCT No.: PCT/EP2017/055888

§ 371 Date: Oct. 23, 2018

(30) Foreign Application Priority Data
Mar. 16, 2016 (DE) 10 2016 104 880.1

(51) Int. Cl. A61H 1/02

(52) U.S. Cl. CPC A61H 1/0274; A61H 2201/0165; A61H 2201/5064; A61H 2201/1607; A61H 2201/1207; A61H 2201/5084; A61H 2201/165; A61H 2201/1638; A61H 2201/5069

(57) ABSTRACT

An orthopedic device for at least one upper extremity, the device comprising at least one positioning element that has at least two movement elements which can be moved one relative to another in a first direction, wherein a movement of the movement elements relative to one another in a first direction encounters a resistance and the device comprises a control unit configured to adjust this resistance depending on the position and/or the location of the head of the wearer of the device.

The invention relates to an orthopedic device for at least one upper extremity, said device comprising at least one positioning element that has at least two movement elements which can be moved one relative to another in a first direction.

An orthopedic device may be a prosthesis or an orthosis, especially an exoskeleton. In the present case, it is designed for at least one upper extremity such that is supports, braces, protects or replaces a part of one or both arms and/or one or both shoulders and/or the back. Many different configurations of this type of orthopedic device are known from the prior art; they have at least one joint by means of which two components of the orthopedic device can be arranged relative to one another such that they can be moved, and connected to one another.

Orthopedic devices are often used to support, brace, guide or protect joints in the upper extremity. For example, with an elbow orthosis, the joint connects a part of the upper arm and a part of the lower arm of the orthopedic device such that they are moveable, thereby enabling the joint to take on the function of an elbow joint for the orthosis. Of course, different joints for different orthoses and different body parts of the upper extremity are known from the prior art.

U.S. Pat. No. 3,769,636 describes a wheelchair that is especially well-suited to people with four paralyzed limbs. A control device is arranged at the head, the control unit being connected to the wheelchair via several universal joints. It is thereby possible to record movements of the head which can subsequently be used to move, for example, an arm rest or an arm support according to the needs of the patient. This means that an otherwise completely immobile arm supported by an arm support is moved via actuators and motors.

U.S. Pat. No. 4,865,610 describes a similar control device that can be controlled, for example, by blowing or sucking, biting pressure or moving the head.

For instance, WO 2012/099995 A2 describes an orthopedic device which aims to support people who often have to work with outstretched arms, particularly above the head. It has arm support braces and compensation elements that may comprise tensioned springs in particular and by means of which a force is permanently applied to the upper arm, which pushes it (the upper arm) upwards. This renders the work in what is otherwise a very uncomfortable position easier. The force apt plied by the spring elements serves to counterbalance the actual weight of the arm itself such that the wearer of the orthopedic device no longer has to exert the upper arm force needed for such a movement by themselves. By adjusting the tension of the springs being used, the force applied prior to using the orthopedic device can be adjusted, for example to meet the needs of various patients, these needs being caused by, for instance, arms of varying weight.

A similar device is disclosed in US 2014/0158839 A1.

However, it is disadvantageous that during device operation, the force applied and thus a resistance encountered by the movement of the movement elements of the at least one positioning element in the first direction cannot be adjusted. In an example known from the prior art, the force renders it easier to hold the arm in an elevated position; however, it naturally makes it more difficult to lower the arm. The force applied thus defines a resistance that counteracts a movement of the joint which corresponds to the lowering of the arm. In the example known from the prior art, this resistance is only present in one movement direction of the joint; however, it can be exerted in both or several directions in other embodiments.

The invention therefore aims to further develop an orthopedic device in such a way that the resistance which opposes the movement of the movement element of the positioning element in the first direction can be controlled and adjusted as intuitively and easily as possible.

The invention solves the problem posed by way of an orthopedic device for at least one upper extremity according to the generic term in claim 1, which is characterised by the fact that a movement of the movement elements relative to one another in the first direction encounters a resistance and that the device comprises a control unit which is configured to adjust the resistance depending on a position and/or location of the head of the wearer of the device.

With the orthopedic device according to the invention, the position and/or location of the head of the wearer of the device is used to determine how great the resistance should be which opposes a movement of the movement elements of the at least one positioning element in the first direction. This renders an intuitive control possible without having to use the hands or arms. If the orthopedic device is an orthosis, hands and arms—if applicable—are restricted in terms of their motor skills or should be protected from excessive stresses and extreme movements. Additional movements for the adjustment of the resistance are not necessary with the orthopedic device according to the invention. If the orthopedic device is a prosthesis, hands or parts of the arm are no longer provided in a natural form, such that it would either be difficult or not at all possible to control the device via a setting executed through the manual activation of an activation element. In particular, when a supporting orthopedic device is used to support people who, for example, have to work above their heads or in uncomfortable positions, the orthopedic device according to the invention that is controlled by the position and/or location of the head is advantageous as the hands—although they are available and not impaired in terms of their motor abilities—need not be used, thereby freeing them up for other activities.

A positioning element within the meaning of the present invention may be a joint, the at least two movement elements of which can be pivoted relative to one another, or a sliding device whose length, for example, can be changed such that the two movement elements can be adjusted relative to one another, as is the case with telescopic rods.

A positioning element within the meaning of the present invention may also be a ball joint. In this case, a pivoting of the at least two movement elements in each direction, at least in almost every direction, is possible. For instance, damping elements or braking elements may be utilized to adjust a resistance which counterbalances this type of pivoting of the at least two movement elements in a pivot direction. In this case, the force applied to the joint by the wearer of the orthopedic device or a torque can be measured or recorded and used as a control parameter for the resistance that counterbalances the respective movement. While the control unit adjusts the resistance in the first direction depending on the position and/or location of the head, the same resistance or another resistance can be used in every other direction insofar as one or several sensors identifies that the wearer of the orthopedic device wishes to move the at least two movement elements, which form the ball joint in the present example, in a different direction to the first.

If the at least one positioning element is designed to be a ball joint, the at least two movement elements generally slide against each other along ball segment-shaped surfaces. The resistance can be infinitely adjusted by way of the pressure with which the two movement elements are pushed or pressed onto one another.

Regardless of the configuration of the positioning element, a controlling of the resistance may also comprise the release or blocking of the movement in the first direction depending on the position and/or location of the head of the wearer of the orthopedic device by locking the positioning element.

In a preferred configuration, the at least two movement elements can be moved freely relative to one another in a second direction which is in the opposite direction to the first.

The control unit is preferably a mechanical, electronic or mechatronic control unit. In particular, the use of a mechanical control unit, which can preferably function fully without any electronic components, is advantageous as it is not necessary to provide any external energy supply for electronic components and the susceptibility to errors is reduced; it also renders any necessary repairs easier.

The control unit preferably has at least one head support element which is arranged in such a way that its position is adjusted relative to at least one further component of the control unit, at least at the point when the head of the wearer is moved in at least one pre-defined direction. The head support element is preferably ergonomically adjusted to fit the shape of the head and padded such that the use of the orthopedic device is as comfortable as possible. The head support element may preferably be coupled with a further component of the control unit via a transmission element, which can preferably transfer compression and tensile forces. If the head now moves in at least one pre-defined direction, thereby changing the position and/or location of the head, this movement is transferred to the at least one head support element and thus also to the transmission element, and transmitted to the other components of the control unit. This renders it possible to tension or loosen springs or activate switches, for example, in order to change the resistance encountered by a movement of the joint in at least one direction, i.e. to increase or reduce it.

The at least one head support element can be arranged in a wide range of positions on the head of the wearer. An arrangement at the back of wearer's head is just as conceivable as a positioning on the wearer's chin, forehead or throat, wherein the throat is considered as belonging to the head in this context.

The transmission element may be available in the form of a rod which is, if necessary, spring-loaded towards the head of the wearer of orthopedic device. The head support element is preferably arranged at the back of the head of the wearer of the orthopedic device. If the wearer bends their head backwards, one refers to it as a caudal movement: in this case, the head support element is moved downwards, which is transferred to the further components of the control unit via the transmission element. However, if the person lowers their head, a device by means of which a pre-tension can be applied, for example a spring, ensures that the transmission element and therefore also the head support element follows this movement of the head such that the head support element and the head of the wearer of the orthopedic device always come into contact with one another.

Alternatively, only one tensile force can be transferred by the least one transmission element. In this case, a tensile force can, for example, unlock or lock a joint by, for instance, engaging or disengaging a pawl or locking lever with a gearwheel or another toothed device. This can be reversed using a passive mechanism, such as a spring, which puts the pawl or locking lever back into its original state.

The incline of the head relative to the horizontal is a particularly preferable control parameter as on the one hand, a corresponding movement of the head can be easily detected and transferred via mechanical elements, and on the other hand, the movement of the head in the respective direction corresponds to the natural working process, for example when work is being performed above the head, and to the resulting natural movement. If work is performed above the head, such as an installation or the painting of a ceiling, the respective person will turn their head upwards anyway to watch what their hands are doing. In this case, the support of upper arm brace elements, for example, is required to facilitate the holding up of the hands as much as possible. However, when the work carried out above the head is complete, the wearer of the orthopedic device lowers their head and the resistance which counterbalances a movement of the at least one joint in one direction can be changed again. In this case, it should be noted that a resistance encountered by a movement of the joint in one direction supports, where applicable, a movement of the joint in the opposite direction. Within the scope of the present invention, this embodiment is also understood to mean a resistance which counterbalances a movement of the at least one joint in at least one direction.

However, the incline of the head relative to the horizontal is not a suitable control parameter for some applications. For example, this relates to tasks which involve the person working whilst lying on their back, as is sometimes the case in car workshops, for instance, when a mechanic is lying underneath the car and working. In this case, it is advantageous to define an angle of inclination of the head relative not to the horizontal, but rather relative to the transverse plane of the wearer of the device. The horizontal is generally defined as a plane that is vertical on the earth's gravitational field. When a person stands upright or walks, it (the horizontal) at least almost aligns with the transverse plane of the person's body. However, it is often practical to define an angle of inclination of the head relative to the transverse plane of the wearer, particularly with applications for which this is not the case. In this case, a position sensor or location sensor could be positioned on the torso of the wearer of the device, the sensor being connected to the torso so that it is stationary and especially torque-proof, such that the position and location of a transverse plane can be easily defined. This may be given as an angle to the horizontal, for example. If the angle of the head to the horizontal, for instance, is measured at the same time, an angle of the head relative to the transverse plane can also be determined on the basis of a combination of the two results.

The control unit preferably blocks a movement of the movement elements in the first direction if the angle of inclination of the head relative to the horizontal or the transverse plane exceeds a pre-defined limit. This is especially advantageous for a supporting orthopedic device, which is advantageous in the previously described case of a wearer of the device who performs work above their head. If the head is raised so far that a pre-defined limit, which may be a pre-defined angle for instance, is exceeded, a movement of the movement elements that corresponds to a lowering of the arm is blocked. The wearer of the orthopedic device does not have to then apply any more force via the shoulders or the arms in order to keep the arms in this otherwise uncomfortable position.

The control unit preferably allows for the movement of the joint in the at least one direction as long as the angle of inclination of the head relative to the horizontal and/or a transverse plane decreases and/or does not reach the pre-defined limit. This situation arises if the person who is working above their head lowers their gaze and therefore their head. The device preferably detects the lowering of the head and the control unit also once again allows for the movement of the movement elements in the originally blocked direction. In the example described, this corresponds to a lowering of the arms, which should always be possible when the head is lowered. If the head is raised again or the lowering movement of the head completed, the control unit once again blocks the movement of the movement elements in the corresponding direction, as long as the angle of inclination of the head relative to the horizontal still exceeds the pre-defined limit. Otherwise, the movement remains possible.

It is of course also possible to not completely block the movement of the movement elements if a measurement parameter is exceeded, such as the angle of inclination of the head relative to the horizontal or a transverse plane, but rather to make it more difficult, for instance by applying a freely adjustable force, where applicable. This may occur, for example, by way of a varying, for instance an increasing or decreasing force, or by way of a force path that can be freely selected. This may also be realized using different force paths for different measurement parameters or different ranges in which the measured value of the respective measurement parameter lies; these force paths may be stored, for example, in an electronis data storage device that is specifically provided for this purpose. Of course, the force may also be designed to be constant across the entire range of the measurement parameter or sections thereof. In the example embodiment described, this would mean supporting the arms in the position above the head but still allowing them to lower. The force applied for this case, which counterbalances a movement of the movement elements in the one direction, can be made to depend on the respective angle of inclination, such that it (the force) increases, for example, the more the wearer of the orthopedic device raises their head. Several limits are also possible in this case which, if exceeded, result in an increase in the force, for example; in particular, if the last limit is exceeded, a complete locking, disabling and blocking of the positioning element is possible. In this case, the disabling is possible in one direction and in both directions of the positioning element.

In a preferred configuration, the orthopedic device has at least two positioning elements and the control unit is configured to adjust a resistance encountered by a movement of the movement elements of at least one of the at least two positioning elements, depending on a position and/or location of the head of the wearer of the device. This configuration is especially advantageous if the orthopedic device is designed for both upper extremities and thus exerts an effect on both arms or parts of both arms.

It has been proven to be advantageous if the control unit is configured to adjust the resistance for the at least two positioning elements independently of one another. In this case in particular, but also in all other configurations, it is advantageous to use not only the incline of the head relative to the horizontal or a transverse plane as a control parameter, or not to use it at all: instead, a rotation of the head to the right and left or a tilting of the head about an axis that runs from dorsal to ventral could be used as a control parameter.

The control unit preferably has at least two head support elements which are arranged in such a way that their position changes relative to at least one further component of the control unit, at least when the head of the wearer is moved in at least one pre-defined direction. As with the configuration with only one head support element, the position of each of the head support elements or only one or fewer of the head support elements can of course change if the head is moved in several directions. With two independent head support elements, it is especially easy to also mechanically adjust the resistances for at least two joints independently of one another.

The device preferably has at least one sensor for detecting the position and/or location of the head of the wearer and for sending electronic data to the control unit depending on the detected position and/or location. In addition or instead of a mechanical controlling, this guarantees an electronic or mechatronic controlling, as the position and/or location of the head detected by the sensor is transmitted to the control unit by way of corresponding signals; the control unit subsequently ensures—either electronically or mechanically—that the corresponding resistance is set. To this end, it sends, for example, control signals to an adjustment device, which is preferably arranged directly on the positioning element and, in response to the incident control signals, adjusts a resistance that counterbalances the movement of the corresponding joint in at least one direction. This may also result in a change in the force or the resistance, or even a complete locking or unlocking. Of course, this is also possible depending on the detected position and/or location of the head.

The at least one sensor is preferably a location sensor, an angle sensor, a movement sensor or an acceleration sensor, by means of which the location, the position, the movement or the acceleration of the head can consequently be measured. One or several pressure sensors, rotation sensors, magnetic field sensors or distance sensors may also be used, for instance for ultra-sound or close-rangeradar measurements. The joint position itself can be controlled and adjusted using sensor information in particular, i.e. the positions and/or locations detected by the sensor; this is also possible with mechanical recording devices. This is achieved via a resistance encountered by the movement of the joint in at least one direction, i.e. in particular a force acting on the joint and/or on at least one of the components that are connected to one another by a joint. This renders it possible, for instance, to control the position or location of a prosthetic hand with the head alone, thereby ensuring that, for example, the position of the hand follows an orientation or direction of rotation of the head.

In a preferred configuration, the at least one sensor can be fixed to a head support element which has been provided specifically for this purpose. Alternatively or additionally, it is also possible to fix at least one sensor to an object which is already worn on the head of the wearer of the orthopedic device. This may be glasses, a headband or, in the wearer's work environment, a helmet or another device.

In addition to the control of the resistance depending on the position and/or location of a head, an acceleration of the head, for example, may also be used as a further control parameter. In this case, it is of course advantageous if the at least one sensor comprises at least one acceleration sensor. If the measured acceleration exceeds, for instance, a pre-defined threshold value, which is preferably designed such that it can be adjusted and—in an especially preferred configuration—can be adjusted by the wearer of the orthopedic device themselves, this is classified as a reflexive movement which enables, for example, an immediate release of the movement in the first direction.

In particular, in the event of a mechanical detection of the head position via at least one head support element, it is of course also possible to configure the mechanics such that a tension is exerted on a transmission element if the wearer of the orthopedic device raises their head, i.e. tips it backwards. In the opposite direction, i.e. when the head is tipped forward, i.e. lowering the head, the tension on the wire or the similar mechanism, which is used as a transmission element, is reduced; this change in tension is used to control the resistance, for example to release a locking of the joint.

In the following, an example of an embodiment of the present invention will be explained in more detail by way of the attached drawings: They show:

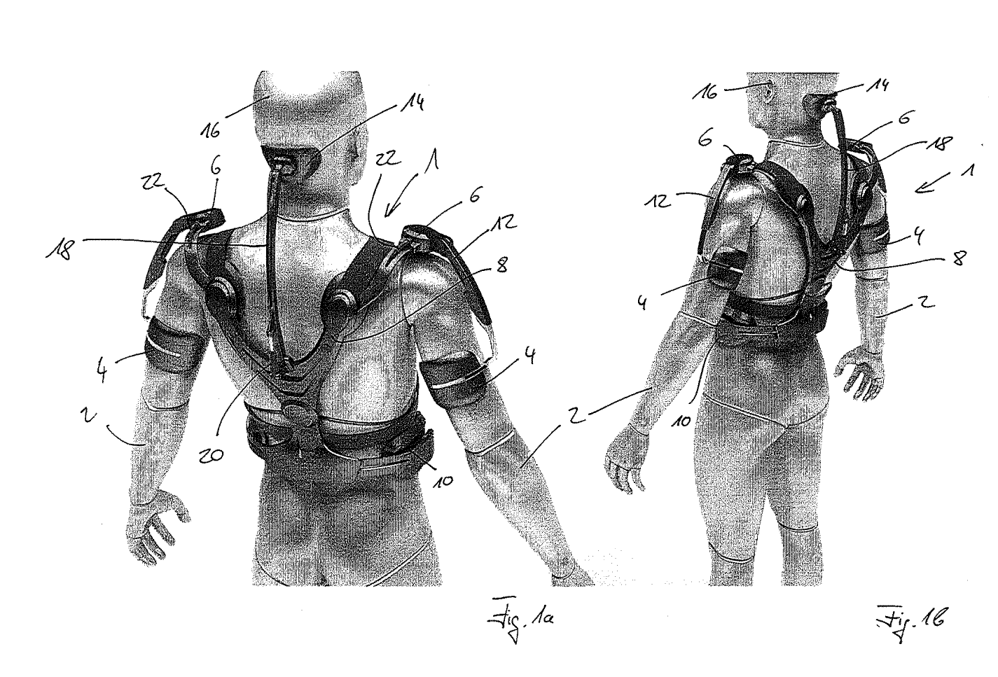

FIG. 1a and 1b—the schematic depiction of a person wearing an orthopedic device according to a first example of an embodiment of the present invention,

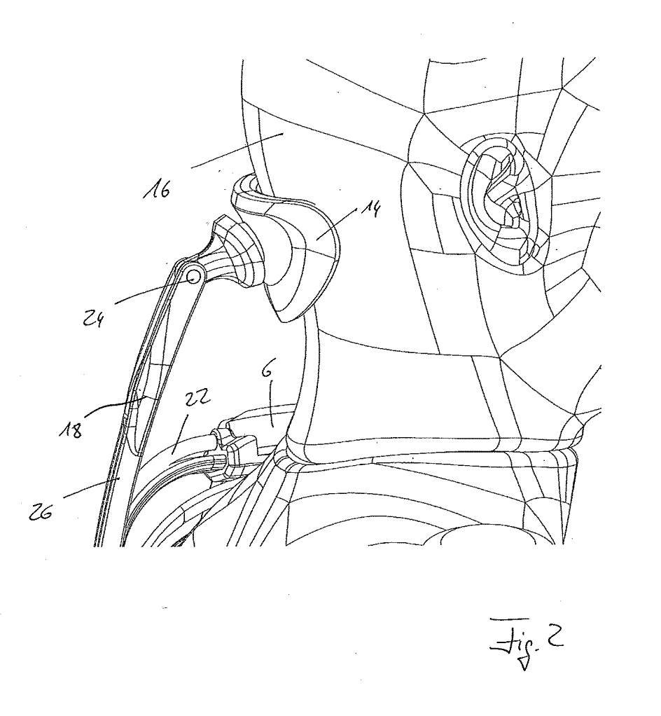

FIG. 2—an enlarged detail and

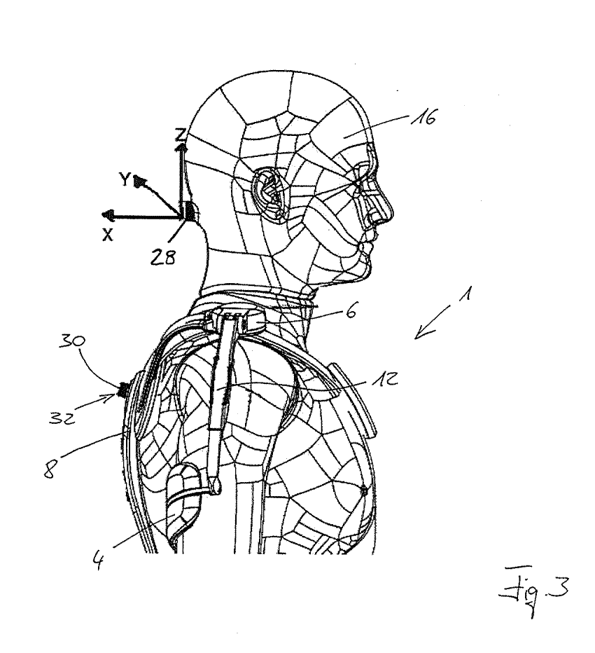

FIG. 3—a further example of an embodiment.

FIGS. 1a and 1 b depict an orthopedic device 1 according to a first example of an embodiment of the present invention. It relates to a brace device with which the arms 2 of the wearer of the device 1 can be supported. To this end, the device has two arm supports 4 that are flexibly arranged on a back element 8 via joints 6, which are formed by the positioning elements in this case, and may be designed as, for example, padding, an arm bracket, a collar, an arm guide or arm accommodation. This comprises brace elements 10 that are used to support the orthopedic device 1 on the back and torso of the wearer. The joint 6 enables a movement of a connecting element 12 relative to the back element 8, such that every movement of the arm 2 can be followed, meaning that the arm support 4 always fits closely to the arm.

The orthopedic device 1 also has a head support element 14, which fits closely on the head 16 of the wearer and follows a movement of the head. Every movement of the head that is transferred to the head support element 14 is transmitted to the control unit via a transmission element 18. In the example of an embodiment depicted, the control unit comprises a cylinder 20 that is compressed or uncompressed upon a movement of the head.

If the wearer of the orthopedic device 1 tilts their head 16 back, as depicted in FIGS. 1a and 1b, a pin is pushed into the cylinder, thereby activating a locking element. A Bowden wire 22 can be seen entering the individual joints 6. This renders it possible to transfer the control signal, which has been transferred via the cylinder 20, into the joint 6, where it (the control signal) ensures the adjustment of the resistance that counterbalances a movement of the joint 6 in a specific direction, and the complete locking of the joint 6, where applicable.

FIG. 2 shows an enlarged section of this type of device. From the head 16 of the wearer of the head support element 14, it is clear to see that it (the support element) is ergonomically shaped and padded. It is fixed to a brace structure 26 via a joint 24; the actual transmission element 18 runs inside this structure. This is connected at the end, not depicted in FIG. 2, to the piston of the cylinder 20, such that a pivoting of the head support element 14 about the joint axis of the joint 24 leads to a movement of the piston inside the cylinder 20, causing the movement to be detected and translated into a control signal. For any movements made by the head 16 of the wearer of the device 1 which do not lead to a pivoting of the head support element 14 about the joint axis of the joint 24, a sensor or several sensors may be arranged, for instance, on the head support element 14; these sensors detect this type of movement and translate it, for example, into electronic control signals. FIG. 2 also shows the joint 6 with the corresponding Bowden wire 22.

A particularly simple configuration of a locking and unlocking device, as it can be used in all embodiments of the invention described here, is comprised of a pawl, which engages with and/or disengages from a toothed rack or a gearwheel by way of, for example, a mechanical transmission element via a movement of the head; it thus enables a movement of the two movement elements of the positioning element in the second direction, but not in the first direction, when the catch engages with the gearwheel or the toothed rack. The movement in both directions is once again possible when it is disengaged.

FIG. 3 depicts a further example of an embodiment of the present invention. In this case, the orthopedic device also has a joint 6 that is arranged on the back element 8 and that is connected to the arm support 4 via the connecting element 12. Unlike the examples of embodiments depicted thus far, a sensor 28 is arranged on the head 16, which identifies the location of the head 16 and communicates this to a receiver 30 via a wireless connection. The data transferred by the sensor 28 can be used by an electronic control unit, not depicted, to generate control signals for controlling the joint 6.

The sensor 28 may be integrated into a head brace or worn directly on the head and record, for example, its spatial orientation. Depending on this orientation of the head, the joint 6 is locked or unlocked upon a rotation about the y-axis as shown in FIG. 3. This mechatronic joint 6 can be designed in such a way that the locking does not occur until the joint is above a specific position. In this case, a further movement of the two movement elements of the joint 6 in the first direction is prevented; a movement in the second direction remains possible. An additional sensor 32 can be arranged on the torso for determining the relative location of the head 16 to the torso of the wearer; this sensor can identify a relative position of the head to the torso and then, for instance, use an angle relative to a transverse plane as a control parameter. This is necessary, for example, if the centres of gravity of the head 16 and the torso are not in balance. This is this case with a bent posture, for instance, in which the locking position of the joint 6 must be adapted. Alternatively, the locking positions may also be controlled via different programmes that are coordinated to match various working postures of the wearer. Alternatively or additionally, the location of the sensor 28 can be adjusted according to the working posture, for example, or a resting position or neutral position can be set and calibrated in order to block the joint at a corresponding earlier or later point.

### REFERENCE LIST

1 orthopedic device
2 arm
4 arm support
6 joint
8 back element
10 brace element
12 connecting element
14 head support element
16 head
18 transmission element
20 cylinder
22 Bowden wire
24 joint
26 brace structure
28 sensor
30 receiver
32 additional sensor

1. An orthopedic device for at least one upper extremity, the device comprising:
at least one positioning element that has at least two movement elements which can be moved one relative to another, wherein a movement of the at least two movement elements relative to one another in a first direction encounters a resistances; and
a control unit configured to adjust the resistance depending on at least one of a position and a location of a head of a wearer of the device.

2. The orthopedic device according to claim 1, wherein the at least two movement elements can be freely moved relative to one another in a second direction, which is opposite the first direction.

3. The orthopedic device according to claim 1, wherein the control unit is a mechanic, electronic or mechatronic control unit.

4. The orthopedic device according to claim 3, wherein the control unit has at least one head support element which is arranged in such a way that a position of the at least one head support element changes relative to at least one further component of the control unit if the head of the wearer is moved in at least one pre-defined direction.

5. The orthopedic device according to claim 1, wherein the control unit blocks a movement of the at least one positioning element in at least one direction if an angle of inclination of the head relative to a transverse plane exceeds a pre-defined limit.

6. The orthopedic device according to claim 5, wherein the control unit enables a movement of the at least one positioning element in the first direction as long as the angle of inclination of the head relative to the transverse plane at least one of decreases and does not reach the pre-defined limit.

7. The orthopedic device according to claim 1, wherein the device comprises at least two positioning elements, the control unit being configured to adjust the resistance encountered by a movement of the at least two movement elements in the first direction relative to one another for the at least two positioning elements independently of one another.

8. The orthopedic device according to claim 1, wherein the control unit has at least two head support elements which are arranged in such a way that a position of the at least two head support elements changes relative to at least one further component of the control unit if the head of the wearer is moved in at least one pre-defined direction.

9. The orthopedic device according to claim 1, further comprising at least one sensor for detecting at least one of the position and the location of the head of the wearer and for sending electronic signals to the control unit depending on the detected at least one of the position and the location.

10. The orthopedic device according to claim 9, wherein the at least one sensor is a location sensor, an angle sensor, a movement sensor or an acceleration sensor.

11. An orthopedic device for use with at least one upper extremity, the device comprising:
at least one positioning element having at least two movement elements, the at least two moving elements being movable relative to each other, wherein a movement of the at least two movement elements relative to each another in a first direction encounters a resistance; and
a control unit configured to adjust the resistance depending on at least one of a position and a location of a head of a wearer of the device.

12. The orthopedic device according to claim 11, wherein the at least two movement elements can be freely moved relative to one another in a second direction, which is opposite the first direction.

13. The orthopedic device according to claim 11, wherein the control unit is a mechanic, electronic or mechatronic control unit.

14. The orthopedic device according to claim 11, wherein the control unit has at least one head support element, and a position of the at least one head support element changes relative to at least one further component of the control unit if the head of the wearer is moved in at least one pre-defined direction.

15. The orthopedic device according to claim 11, wherein the control unit blocks a movement of the at least one positioning element in at least one direction if an angle of inclination of the head relative to a transverse plane exceeds a pre-defined limit.

16. The orthopedic device according to claim 15, wherein the control unit enables a movement of the at least one positioning element in the first direction as long as the angle of inclination of the head relative to the transverse plane at least one of decreases and does not reach the pre-defined limit.

17. The orthopedic device according to claim 11, wherein the device comprises at least two positioning elements, the control unit being configured to adjust the resistance encountered by a movement of the at least two movement elements in the first direction relative to one another for the at least two positioning elements independently of one another.

18. The orthopedic device according to claim 11, wherein the control unit has at least two head support elements, and a position of the at least two head support elements changes relative to at least one further component of the control unit if the head of the wearer is moved in at least one pre-defined direction.

19. The orthopedic device according to claim 11, further comprising at least one sensor for detecting at least one of the position and the location of the head of the wearer and for sending electronic signals to the control unit depending on the detected at least one of the position and the location.

20. The orthopedic device according to claim 19, wherein the at least one sensor is a location sensor, an angle sensor, a movement sensor or an acceleration sensor.
